(19) United States
(12) Patent Application Publication
(10) Pub. No.: US 2023/0342742 A1
(43) Pub. Date: Oct. 26, 2023

(54) TRANSACTION PLATFORM AND METHOD FOR IMAGE AND SHORT VIDEO COPYRIGHT BASED ON BLOCKCHAIN

(71) Applicant: Hainan Academy of Ocean and Fisheries Sciences, Haikou (CN)

(72) Inventors: Zhongjie WU, Haikou (CN); Xiaoyin CHEN, Haikou (CN); Yuanchao LI, Haikou (CN); Shiquan CHEN, Haikou (CN)

(21) Appl. No.: 18/297,578

(22) Filed: Apr. 7, 2023

(30) Foreign Application Priority Data
Apr. 13, 2022 (CN) 202210394502.1

(51) Int. Cl. G06Q 20/12; G06Q 30/0601

(52) U.S. Cl. CPC G06Q 20/1235; G06Q 30/0623; G06Q 2220/00

(57) ABSTRACT

A transaction platform for image and short video copyright based on blockchain, including: a back-end server, for receiving an authentication service request; a label generation module, for generating an image or short video label; an extraction module, for crawling images or short videos from the network platform according to the image or short video label; and an audit module, for comparing the to-be-authenticated image or short video with the images or short videos from the network platform, where if the to-be-authenticated image or short video is inconsistent with the images or short videos from the network platform, audit is passed; and if the to-be-authenticated image or short video is consistent with one of the images or short videos from the network platform, the audit fails. A transaction method for image and short video copyright based on blockchain is further provided.

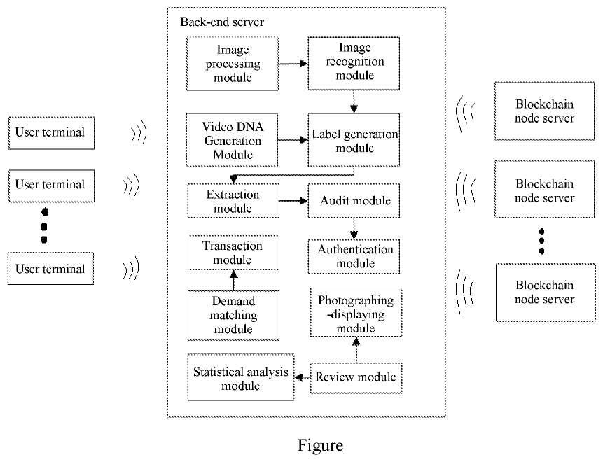

### CROSS-REFERENCE TO RELATED APPLICATIONS

This application claims the benefit of priority from Chinese Patent Application No. 202210394502.1, filed on Apr. 13, 2022. The content of the aforementioned application, including any intervening amendments thereto, is incorporated herein by reference in its entirety.

### TECHNICAL FIELD

This application relates to self-media technology based blockchain, and more particularly to a transaction platform and method for image and short video copyright based on blockchain.

### BACKGROUND

With the rapid development of self-media, various short video websites have emerged, and the number of short video users has rapidly risen. Various short video platforms have become an important interaction and communication medium for the public. The existing short video sharing platforms only act as social networking for creation and publishing of short videos. However, with the sharp growth of the number of short videos, the problem of piracy and infringement has become increasingly prominent.

In order to solve the problem of short video piracy, an audit and authentication mode has been developed for the authentication of short videos. But in the process of audit and authentication, individual short videos are crawled directly from network platforms through crawler technology, and then the short video to be authenticated is compared with the crawled short videos one by one. If the short video to be authenticated is inconsistent with the short videos crawled from the network platforms, the audit is passed; and if the short video to be authenticated is consistent with a crawled short video, the audit fails. Considering there is a large number of short videos on individual network platforms, massive system resources will be consumed for comparison and analysis, resulting in poor audit and authentication efficiency.

The object of this application is to provide a transaction platform for image and short video copyright based on blockchain to simplify the comparison and analysis in the process of audit and authentication, reduce the system resource consumption, and improve efficiency.

This application provides a transaction platform for image and short video copyright based on blockchain, including:

a back-end server;

a blockchain node server; and

a user terminal;

wherein the back-end server includes an image processing module, an image recognition module, a video DNA generation module, a transaction module, a label generation module, an extraction module, an audit module, and an authentication module;

the user terminal is configured for sending an authentication service request to the back-end server; and

the back-end server is configured to receive the authentication service request:

if the authentication service request is an image authentication service request, the image processing module is configured to process a to-be-authenticated image, and the image recognition module is configured to recognize the to-be-authenticated image to generate an image recognition result; and
the label generation module is configured for generating an image label according to the image recognition result; the extraction module is configured for crawling images from a network platform according to the image label; the audit module is configured for comparing the to-be-authenticated image with the images crawled from the network platform: if the to-be-authenticated image is inconsistent with the images crawled from the network platform, an audit is passed; if the to-be-authenticated image is consistent with one of the images crawled from the network platform, the audit fails; and if the to-be-authenticated image passes the audit, the authentication module is configured for uploading the to-be-authenticated image, and name and identification number of a user of the to-be-authenticated image to a third-party public blockchain through the blockchain node server for copyright confirmation, and obtaining a blockchain on-chain code and an original image certificate certified by a judicial authority; and

if the authentication service request is a short video authentication service request, the video DNA generation module is configured to generate a short video DNA; the image processing module is configured to process a to-be-authenticated short video according to the short video DNA, and the image recognition module is configured to recognize the to-be-authenticated short video according to the short video DNA to generate a short video recognition result; and
the label generation module is configured for generating a short video label according to the short video recognition result; the extraction module is configured for crawling short videos from the network platform according to the short video label; the audit module is configured for comparing the to-be-authenticated short video with the short videos crawled from the network platform: if the to-be-authenticated short video is inconsistent with the short videos crawled from the network platform, an audit is passed; if the to-be-authenticated short video is consistent with one of the short videos crawled from the network platform, the audit fails; and if the to-be-authenticated short video passes the audit, the authentication module is configured for uploading the to-be-authenticated short video, and name and identification number of a user of the to-be-authenticated short video to the third-party public blockchain through the blockchain node server for copyright confirmation, and obtaining a blockchain on-chain code and an original short video certificate certified by the judicial authority; and

the transaction module is configured for transaction of a certified image or short video.

In an embodiment, the authentication service request includes an image classification description information or a short video classification description information; the label generation module is configured to verify the image recognition result according to the image classification description information, and generate the image label; and the label generation module is also configured to verify the short video recognition result according to the short video classification description information, and generate the short video label.

The beneficial effects are as follows. When the user terminal submits an authentication service request, the classification description information of the to-be-authenticated image or the to-be-authenticated short video is sent, so as to obtain the artificial preliminary classification description information, which is used to verify the image recognition result or the short video recognition result, so as to ensure the accuracy of the generated image label or short video label, thereby accurately crawling the image or short video under the same label, accurately matching after collecting the purchaser demand information, improving the success rate of transaction, and improving the user experience.

In an embodiment, the user terminal is further configured for sending a purchase request to the back-end server;

the purchase request includes demand information; the demand information includes classification information of a to-be-purchased image or a to-be-purchased short video; and

the transaction platform further includes a demand matching module; the demand matching module is configured for matching the classification information of the to-be-purchased image with the image label or matching the classification information of the to-be-purchased short video with the short video label, and sending a matching result to the user terminal.

The beneficial effects are as follows. The image label or the short video label is not only used to crawl the corresponding image or short video on the network platform during the audit process, but also used to match demand according to the demand information in the purchase request of the user terminal, so as to match the classification information with the image label or short video label, and send the matching result to the user terminal, so as to achieve accurate information push, rather than push all images or short videos to the user which results in that it is difficult for users to screen, and unnecessary information similar to many spam advertisements is formed, thereby improving the efficiency of purchaser access to information.

In an embodiment, the user terminal is further configured for sending an exhibition request to the back-end server; and the audit module is configured to audit the exhibition request, if the exhibition request passes an audit, an exhibition is permitted; and

the transaction platform further includes a photographing-displaying module; and the photographing-displaying module is configured to photograph and display a to-be-exhibited image after receiving exhibition-permitted information.

The beneficial effects are as follows. Through this design, the platform provides photographing-displaying function, so as to promote the communication of mass self-media and increase the transaction volume.

In an embodiment, the transaction platform further includes a review module;

wherein the user terminal is configured to send image, short video or photographic picture review information to the back-end server; and

the review module is configured to publish the image, short video, or photographic picture review information.

The beneficial effects are as follows. Through the review module, the user terminal can send the review information of the image, the short video, or the photographic image to the back-end server, so as to increase interactive communication and promote the quality of images or short videos.

In an embodiment, the transaction platform further includes a statistical analysis module;

wherein the statistical analysis module is configured to statistically analyze the image, short video or photographic picture review information to generate a statistical result; and the statistical result is configured to be pushed to the user terminal according to a request of the user terminal.

The beneficial effects are as follows. Through the statistical analysis module, the review information of the image, the short video or the photographic image is statistically analyzed to obtain the statistical result. The images or the short videos are commented from the public perspective, and review opinions are collected, so as to appreciate, evaluate, and promote more and better works. If the purchaser intends to buy the work, the statistical results can be pushed to the user terminal according to the request of the user terminal as a purchase reference.

In an embodiment, the extraction module is configured to crawl a latest image of the same category as the certified image from the network platform according to the image label, and to crawl a latest short video of the same category as the certified short video from the network platform according to the short video label;

if crawled, the extraction module is further configured to retrieve authentication information of the latest image of the same category as the certified image or the latest short video of the same category as the certified short video;

if the authentication information is not retrieved, the latest image is compared with the certified image by the extraction module, or the latest short video is compared with the certified short video by the extraction module; and

if the latest image is consistent with the certified image, or the latest short video is consistent with the certified short video, information that a piracy is monitored is sent by the extraction module to the user terminal of the certified image or the certified short video.

The beneficial effects are as follows. In this application, while monitoring whether there is piracy on the network platform, the image label or short video label can be used, there is no need to crawl all the latest images or short videos on the network platform through crawler technology to analyze and compare, but only need to crawl the latest-uploaded images or short videos of the same category according to the image label or short video label and compare and analyze the certified image or certified short video, the piracy can be monitored, thereby reducing the cost of system monitoring and improve the monitoring efficiency.

In an embodiment, the image recognition module is further configured to determine whether the to-be-authenticated image is blurry according to noise assignment to identify quality of the to-be-authenticated image, and to identify quality of the to-be-authenticated short video according to video frame assignment.

The beneficial effects are as follows. By this design, the quality of the image and the short video can be judged.

This application further provides a transaction method for image and short video copyright based on blockchain, including:

sending, by a user terminal, an authentication service request to a back-end server;

receiving, by the back-end server, the authentication service request;

if the authentication service request is an image authentication service request, processing, by an image processing module, a to-be-authenticated image; identifying, by an image recognition module, the to-be-authenticated image to generate an image recognition result; generating, by a label generation module, an image label according to the image recognition result; crawling, by an extraction module, images from a network platform according to the image label; comparing, by an audit module, the to-be-authenticated image with the images crawled from the network platform, wherein if the to-be-authenticated image is inconsistent with the images crawled from the network platform, an audit is passed; and if the to-be-authenticated image is consistent with one of the images crawled from the network platform, the audit fails; and if the to-be-authenticated image passes the audit, uploading, by an authentication module, the to-be-authenticated image, and name and identification number of a user of the to-be-authenticated image to a third-party public blockchain through a blockchain node server for copyright confirmation, and obtaining a blockchain on-chain code and an original image certificate certified by a judicial authority;

if the authentication service request is a short video authentication service request, generating, by a video DNA generation module, a short video DNA; processing, by the image processing module, a to-be-authenticated short video according to the short video DNA, and recognizing, by the image recognition module, the to-be-authenticated short video according to the short video DNA to generate a short video recognition result; generating, by the label generation module, a short video label according to the short video recognition result; crawling, by the extraction module, short videos from the network platform according to the short video label; comparing, by the audit module, the to-be-authenticated short video with the short videos crawled from the network platform, wherein if the to-be-authenticated short video is inconsistent with the short videos crawled from the network platform, an audit is passed; and if the to-be-authenticated short video is consistent with one of the short videos crawled from the network platform, the audit fails; and if the to-be-authenticated short video passes the audit, uploading, by the authentication module, the to-be-authenticated short video, and name and identification number of a user of the to-be-authenticated short video to the third-party public blockchain through the blockchain node server for copyright confirmation, and obtaining a blockchain on-chain code and an original short video certificate certified by the judicial authority.

Compared to the prior art, this application has the following beneficial effects.
1. In this application, before the images and short videos are certified, an originality examination is conducted, so as to avoid issuing the certification for pirated images or short videos, and ensure the certification reliability.
2. In this application, the originality examination process is different from the existing technology which directly adopts crawler technology to crawl all images or short videos from the network platform for comparison, which involves the consumption of extensive system resources for crawling, identification and comparison, and cumbersome operation. Different from the existing technology, this application generates an image label according to the image recognition result through the label generation module, and crawls the images from the network platform according to the image label through the extraction module. The audit module compares the to-be-authenticated image with the images from the network platform: if the to-be-authenticated image is inconsistent with the images from the network platform, the audit is passed; if the to-be-authenticated image is consistent with one of the images from the network platform, the audit fails. Similarly, this application generates a short video label according to the short video recognition result through the label generation module and extracts the short videos from the network platform according to the short video label through the extraction module. The audit module compares the to-be-authenticated short video with the short videos from the network platform: if the to-be-authenticated short video is inconsistent with the short videos from the network platform, the audit is passed; if the to-be-authenticated short video is consistent with one of the short videos from the network platform, the audit fails. By assigning labels to the images and short videos to be authenticated, the extraction module can crawl images or short videos from the network platform according to the image label or short video label, which will greatly reduce the number of crawled images or short videos, simplify the subsequent analysis, identification, and comparison, and reduce system resource consumption, thereby improving the authentication efficiency.
3. For the to-be-authenticated image passing the audit, the authentication module uploads the to-be-authenticated image, and name and identification number of the user to the third-party public blockchain through the blockchain node server for copyright confirmation, and obtains the blockchain on-chain code and the original image certificate certified by the judicial authority. For the to-be-authenticated short video passing the audit, the authentication module uploads the to-be-authenticated short video, and name and identification number of the user to the third-party public blockchain through the blockchain node server for copyright confirmation, and obtains the blockchain on-chain code and the original short video certificate certified by the judicial authority. By means of the blockchain technology, it not only ensures that the original image or short video cannot be tampered, but also ensures the security and reliability of the authentication.

### BRIEF DESCRIPTION OF THE DRAWINGS

The FIGURE schematically shows a transaction platform for image and short video copyright based on blockchain according to one embodiment of the present disclosure.

### DETAILED DESCRIPTION OF EMBODIMENTS

The disclosure will be further described in detail in conjunction with the embodiments and drawings.

As shown in the FIGURE, a transaction platform for image and short video copyright based on blockchain is disclosed. In this embodiment, the transaction platform is mainly for the public to provide professional image exchange and transaction, invite photography enthusiasts to publish image and video materials, and specially invite photographers to make comments for the explanation of the application field. At present, although there are many self-media sharing platforms, there are fewer communication and transaction platforms specifically for photography enthusiasts, and experts in various fields of biology also need to publish photos for communication and sharing.

A transaction platform for image and short video copyright based on blockchain provided herein includes a back-end server, a blockchain node server, and a user terminal. The back-end server includes an image processing module, an image recognition module, a video DNA generation module, a transaction module, a label generation module, an extraction module, an audit module, an authentication module, a demand matching module, a photographing-displaying module, a review module, and a statistical analysis module.

The user terminal sends an authentication service request to the back-end server. The authentication service request includes an image classification description information or a short video classification description information. The back-end server receives the authentication service request. If the authentication service request is an image authentication service request, the image processing module is configured to process a to-be-authenticated image, and the image recognition module is configured to recognize the to-be-authenticated image to generate an image recognition result. The image recognition module determines whether the to-be-authenticated image is blurry according to the noise assignment in the image recognition process, so as to identify quality of the to-be-authenticated image.

The label generation module generates the image label according to the image recognition results. In an embodiment, the label generation module verifies the image recognition results according to the image classification description information and generates image labels.

The extraction module crawls the images from the network platform according to the image label. The audit module compares the to-be-authenticated image with the images crawled from the network platform. If the to-be-authenticated image is inconsistent with the images crawled from the network platform, an audit is passed. If the to-be-authenticated image is consistent with one of the images crawled from the network platform, the audit fails. If the to-be-authenticated image passes the audit, the authentication module is configured for uploading the to-be-authenticated image, and name and identification number of a user of the to-be-authenticated image to a third-party public blockchain through the blockchain node server for copyright confirmation, and obtaining a blockchain on-chain code and an original image certificate certified by a judicial authority.

If the authentication service request is a short video authentication service request, the video DNA generation module is configured to generate a short video DNA; the image processing module is configured to process a to-be-authenticated short video according to the short video DNA, and the image recognition module is configured to recognize the to-be-authenticated short video according to the short video DNA to generate a short video recognition result. The image recognition module, according to the video frame assignment, further identifies quality of the to-be-authenticated short video. The label generation module generates the short video label according to the short video recognition result. In an embodiment, the label generation module verifies the short video recognition results according to the short video classification description information and generates the short video label.

The extraction module is configured for crawling short videos from the network platform according to the short video label. The audit module is configured for comparing the to-be-authenticated short video with the short videos crawled from the network platform. If the to-be-authenticated short video is inconsistent with the short videos crawled from the network platform, an audit is passed. If the to-be-authenticated short video is consistent with one of the short videos crawled from the network platform, the audit fails. If the to-be-authenticated short video passes the audit, the authentication module is configured for uploading the to-be-authenticated short video, and name and identification number of a user of the to-be-authenticated short video to the third-party public blockchain through the blockchain node server for copyright confirmation, and obtaining a blockchain on-chain code and an original short video certificate certified by the judicial authority.

In this embodiment, the video DNA generation module adopts Alibaba's video DNA technology. Before uploading the short video, using Alibaba Cloud's video DNA service to create a library to record and store short video DNA, the video DNA generation module will upload the to be authenticated short video uploaded by the user terminal to the video DNA library through the video DNA interface provided by Alibaba Cloud. After completing uploading, the video DNA library will automatically generate the new-uploaded short video DNA.

In this embodiment, the classification description information refers to the category and attribute information of the image or short video. For example, the category is birds, the attribute is migration, that is, the uploaded image or short video is an image or short video related to bird migration. The image label or short video label includes category, attribute, and numbering information. In this embodiment, the third-party public blockchain adopts the ant blockchain.

In this embodiment, in order to prevent pirated images or short videos from being transferred between the network platforms, the original creator can timely discover that the work has been stolen, and a monitoring method for online pirated images or short videos is further disclosed. Specifically, the extraction module is configured to crawl a latest image of the same category as the certified image from the network platform according to the image label, and to crawl a latest short video of the same category as the certified short video from the network platform according to the short video label. If crawled, the extraction module is further configured to retrieve authentication information of the latest image of the same category as the certified image or the latest short video of the same category as the certified short video. If the authentication information is not retrieved, the latest image is compared with the certified image, or the latest short video is compared with the certified short video. If the latest image is consistent with the certified image, or the latest short video is consistent with the certified short video, information that a piracy is monitored is sent to the user terminal of the certified image or the certified short video.

For the certified images or short videos, the transaction module is configured for transaction of a certified image or short video. In an embodiment, the transaction module specifically includes an order generation submodule and a payment submodule.

In this embodiment, the user terminal is further configured for sending a purchase request to the back-end server. The purchase request includes demand information. The demand information includes the classification information of the to-be-purchased image or to-be-purchased short video. The transaction platform further includes a demand matching module. The demand matching module matches the classification information of the to-be-purchased image with the image label or matches the classification information of the to-be-purchased short video of the short video label and sends the matching result to the user terminal for the user terminal as a reference information for purchase.

If the purchase intention is reached between the user terminals, the order is generated by the order generation submodule according to the purchase information and works (image or short video) information. Further, the purchaser pays through the payment submodule of the user terminal to generate payment information. The transaction information (seller information, buyer information, payment information) and work information (file hash of original images or short videos) of both user terminals will be uploaded to the blockchain node server to record the current transaction, thereby ensuring that the information cannot be tampered and facilitating later traceability.

The user terminal is also used to send an exhibition request to the back-end server. The audit module is configured to audit the exhibition request. If the exhibition request passes an audit, an exhibition is permitted. The transaction platform further includes a photographing-displaying module. The photographing-displaying module is configured to photograph and display a to-be-exhibited image after receiving exhibition-permitted information.

In this embodiment, the transaction platform further includes a review module. The user terminal is configured to send image, short video or photographic picture review information to the back-end server. The review module is configured to publish the image, short video, or photographic picture review information.

In this embodiment, the transaction platform further includes a statistical analysis module. The statistical analysis module is configured to statistically analyze the image, short video or photographic picture review information to generate a statistical result. The statistical result is configured to be pushed to the user terminal according to a request of the user terminal.

This disclosure also provides a transaction method for image and short video copyright based on blockchain, which specifically includes the following steps.

The user terminal sends the authentication service request to the back-end server. The back-end server receives the authentication service request. If the authentication service request is an image authentication service request, the to-be-authenticated image is processed by the image processing module and recognized by the image recognition module to generate the image recognition result. The label generation module generates the image label according to the image recognition results. The extraction module crawls the images on the network platform according to the image label. The audit module compares the to-be-authenticated image with the images crawled from the network platform. If the to-be-authenticated image is inconsistent with the images crawled from the network platform, an audit is passed. If the to-be-authenticated image is consistent with one of the images crawled from the network platform, the audit fails. If the to-be-authenticated image passes the audit, uploading, by an authentication module, the to-be-authenticated image, and name and identification number of a user of the to-be-authenticated image to a third-party public blockchain through a blockchain node server for copyright confirmation, and obtaining a blockchain on-chain code and an original image certificate certified by a judicial authority.

If the authentication service request is a short video authentication service request, the short video DNA is generated by the video DNA generation module. The to-be-authenticated short video is processed by the image processing module and recognized by the image recognition module according to the short video DNA to generate the short video recognition result. The label generation module generates the short video label according to the short video recognition result. The extraction module crawls the short video from the network platform according to the short video label. The audit module compares the to-be-authenticated short video with the short videos crawled from the network platform. If the to-be-authenticated short video is inconsistent with the short videos crawled from the network platform, an audit is passed. If the to-be-authenticated short video is consistent with one of the short videos crawled from the network platform, the audit fails. If the to-be-authenticated short video passes the audit, uploading, by the authentication module, the to-be-authenticated short video, and name and identification number of a user of the to-be-authenticated short video to the third-party public blockchain through the blockchain node server for copyright confirmation, and obtaining a blockchain on-chain code and an original short video certificate certified by the judicial authority.

### Embodiment 2

The differences from Embodiment 1 are described as follows.

The image recognition module provided herein is also configured to determine the basic artistic conception category of the image according to the proportion of RGB in the image; add auxiliary artistic conception labels to the basic artistic conception category according to the comparison result of the RGB conversion process in the image; perform edge clustering analysis on the objects in the image; determine the type of objects in the image according to the trained neural network model; add the theme artistic conception label according to the type of objects; and finally determine the artistic conception description information according to the basic artistic conception category, auxiliary artistic conception label, and theme artistic conception label. The user terminal is also configured to adopt the user's artistic conception-related information for the required image. The artistic conception-related information includes a tone description information and an object description information. The back-end server is also configured to receive and match the tone description information and object description information with the artistic conception description information, and then sort the corresponding images according to the matching degree.

For example, an image (an award-winning work from a photography festival) shows a flock of birds during the migration in the sunset, forming a pattern of a flying large bird. According to the proportion of RGB, it can be determined that the image is dominated by red and black, and thus the basic artistic conception category has been determined. The conversion process of the sky sunset and the ground, and the sky sunset and the birds in the image basically relates to the contrast of red and black. Then, the objects in the image are determined to be birds through the neural network model (failing to identify the specific species due to the limitation of resolution). Finally, it is determined that the artistic conception description information is red-black, red-black contrast, and birds (namely, the first feature vector). When there is a user demand, the user is required to provide tone description information and object description information, where the tone description information is red and white, and the object description information is birds, and thus another feature vector will be formed. According to the relationship between the two feature vectors, the search results are sorted, and the corresponding situation can be well displayed for the user in the gallery to improve the user's experience when purchasing images.

In fact, in this embodiment, the abstract artistic conception is described through the tones, tone contrast, and objects to form a feature vector (actually, many feature vectors may be formed according to the recognition accuracy). Then, the user requirements are collected to form a second feature vector, and the search results are sorted and displayed according to the relationship between the two feature vectors, thereby improving the user's purchasing experience and improving the transaction efficiency.

Described above are merely some embodiments of the disclosure, which are not intended to limit the disclosure. Those skilled in the art may combine some general knowledge to improve and implement this disclosure under the spirit of the disclosure.

It should be understood that any modifications, variations, and replacements made by those skilled in the art without departing from the spirit of the disclosure should fall within the scope of the disclosure defined by the appended claims.

1. A transaction platform for image and short video copyright based on blockchain, comprising:
a back-end server;
a blockchain node server; and
a user terminal;
wherein the back-end server comprises an image processing module, an image recognition module, a video DNA generation module, a transaction module, a label generation module, an extraction module, an audit module, and an authentication module;
the user terminal is configured for sending an authentication service request to the back-end server; and
the back-end server is configured to receive the authentication service request:
if the authentication service request is an image authentication service request, the image processing module is configured to process a to-be-authenticated image, and the image recognition module is configured to recognize the to-be-authenticated image to generate an image recognition result; and
the label generation module is configured for generating an image label according to the image recognition result; the extraction module is configured for crawling images from a network platform according to the image label; the audit module is configured for comparing the to-be-authenticated image with the images crawled from the network platform: if the to-be-authenticated image is inconsistent with the images crawled from the network platform, an audit is passed; if the to-be-authenticated image is consistent with one of the images crawled from the network platform, the audit fails; and if the to-be-authenticated image passes the audit, the authentication module is configured for uploading the to-be-authenticated image, and name and identification number of a user of the to-be-authenticated image to a third-party public blockchain through the blockchain node server for copyright confirmation, and obtaining a blockchain on-chain code and an original image certificate certified by a judicial authority; and
if the authentication service request is a short video authentication service request, the video DNA generation module is configured to generate a short video DNA; the image processing module is configured to process a to-be-authenticated short video according to the short video DNA, and the image recognition module is configured to recognize the to-be-authenticated short video according to the short video DNA to generate a short video recognition result; and
the label generation module is configured for generating a short video label according to the short video recognition result; the extraction module is configured for crawling short videos from the network platform according to the short video label; the audit module is configured for comparing the to-be-authenticated short video with the short videos crawled from the network platform: if the to-be-authenticated short video is inconsistent with the short videos crawled from the network platform, an audit is passed; if the to-be-authenticated short video is consistent with one of the short videos crawled from the network platform, the audit fails; and if the to-be-authenticated short video passes the audit, the authentication module is configured for uploading the to-be-authenticated short video, and name and identification number of a user of the to-be-authenticated short video to the third-party public blockchain through the blockchain node server for copyright confirmation, and obtaining a blockchain on-chain code and an original short video certificate certified by the judicial authority; and
the transaction module is configured for transaction of a certified image or short video.

2. The transaction platform of claim 1, wherein the authentication service request comprises an image classification description information or a short video classification description information; the label generation module is configured to verify the image recognition result according to the image classification description information, and generate the image label; and the label generation module is also configured to verify the short video recognition result according to the short video classification description information, and generate the short video label.

3. The transaction platform of claim 1, wherein the user terminal is further configured for sending a purchase request to the back-end server;
the purchase request comprises demand information; the demand information comprises classification information of a to-be-purchased image or a to-be-purchased short video; and
the transaction platform further comprises a demand matching module; the demand matching module is configured for matching the classification information of the to-be-purchased image with the image label or matching the classification information of the to-be-purchased short video with the short video label, and sending a matching result to the user terminal.

4. The transaction platform of claim 1, wherein the user terminal is further configured for sending an exhibition request to the back-end server; and the audit module is configured to audit the exhibition request, if the exhibition request passes an audit, an exhibition is permitted; and
the transaction platform further comprises a photographing-displaying module; and the photographing-displaying module is configured to photograph and display a to-be-exhibited image after receiving exhibition-permitted information.

5. The transaction platform of claim 4, further comprising:
a review module;
wherein the user terminal is configured to send image, short video or photographic picture review information to the back-end server; and
the review module is configured to publish the image, short video, or photographic picture review information.

6. The transaction platform of claim 5, further comprising:
a statistical analysis module;
wherein the statistical analysis module is configured to statistically analyze the image, short video or photographic picture review information to generate a statistical result; and the statistical result is configured to be pushed to the user terminal according to a request of the user terminal.

7. The transaction platform of claim 1, wherein the extraction module is configured to crawl a latest image of the same category as the certified image from the network platform according to the image label, and to crawl a latest short video of the same category as the certified short video from the network platform according to the short video label;
if crawled, the extraction module is further configured to retrieve authentication information of the latest image of the same category as the certified image or the latest short video of the same category as the certified short video;
if the authentication information is not retrieved, the latest image is compared with the certified image by the extraction module, or the latest short video is compared with the certified short video by the extraction module; and
if the latest image is consistent with the certified image, or the latest short video is consistent with the certified short video, information that a piracy is monitored is sent by the extraction module to the user terminal of the certified image or the certified short video.

8. The transaction platform of claim 1, wherein the image recognition module is further configured to determine whether the to-be-authenticated image is blurry according to noise assignment to identify quality of the to-be-authenticated image, and to identify quality of the to-be-authenticated short video according to video frame assignment.

9. A transaction method for image and short video copyright based on blockchain, comprising:
sending, by a user terminal, an authentication service request to a back-end server;
receiving, by the back-end server, the authentication service request;
if the authentication service request is an image authentication service request, processing, by an image processing module, a to-be-authenticated image; identifying, by an image recognition module, the to-be-authenticated image to generate an image recognition result; generating, by a label generation module, an image label according to the image recognition result; crawling, by an extraction module, images from a network platform according to the image label; comparing, by an audit module, the to-be-authenticated image with the images crawled from the network platform, wherein if the to-be-authenticated image is inconsistent with the images crawled from the network platform, an audit is passed; and if the to-be-authenticated image is consistent with one of the images crawled from the network platform, the audit fails; and if the to-be-authenticated image passes the audit, uploading, by an authentication module, the to-be-authenticated image, and name and identification number of a user of the to-be-authenticated image to a third-party public blockchain through a blockchain node server for copyright confirmation, and obtaining a blockchain on-chain code and an original image certificate certified by a judicial authority; and
if the authentication service request is a short video authentication service request, generating, by a video DNA generation module, a short video DNA; processing, by the image processing module, a to-be-authenticated short video according to the short video DNA, and recognizing, by the image recognition module, the to-be-authenticated short video according to the short video DNA to generate a short video recognition result; generating, by the label generation module, a short video label according to the short video recognition result; crawling, by the extraction module, short videos from the network platform according to the short video label; comparing, by the audit module, the to-be-authenticated short video with the short videos crawled from the network platform, wherein if the to-be-authenticated short video is inconsistent with the short videos crawled from the network platform, an audit is passed; and if the to-be-authenticated short video is consistent with one of the short videos crawled from the network platform, the audit fails; and if the to-be-authenticated short video passes the audit, uploading, by the authentication module, the to-be-authenticated short video, and name and identification number of a user of the to-be-authenticated short video to the third-party public blockchain through the blockchain node server for copyright confirmation, and obtaining a blockchain on-chain code and an original short video certificate certified by the judicial authority.
